(19) United States
(12) Patent Application Publication
(10) Pub. No.: US 2008/0036300 A1
(43) Pub. Date: Feb. 14, 2008

(54) Utilizing inputs

(76) Inventor: Edward Robert Segal, White Plains, NY (US)

Correspondence Address: Edward Segal, 100 Fisher Ave. Pl990, White Plains, NY, 10602-1990, US

(21) Appl. No.: 11/501,161

(22) Filed: Aug. 9, 2006

(51) Int. Cl. H02J 1/10

(52) U.S. Cl. 307/43

(57) ABSTRACT

A device, device(s), method and/or apparatus that can utilize 1 or more/various forms of inputs for energy

This may be done to perform or enhance various functions or purposes or to provide additional capability such as power, energy, storage, etc.

This may be done to perform or enhance various Functions, or purposes, or to provide additional capability such as power, energy, storage, etc.

### BACKGROUND OF INVENTION

There are many functions or physical devices that can be improved on by utilizing multiple forms of inputs. One set of examples of this relate to utilizing mass, motion, fluids, etc.

Another set of examples of these devices and methods relate to the field of power, energy, backup, alternate sources, etc.

### SUMMARY OF INVENTION

The invention utilizes one or more sources or forms of inputs to provide, generate, produce and/or store energy.

### DESCRIPTION OF PREFERRED EMBODIMENT

Various sources, inputs or forms can be used to provide, generate, produce, or store energy.

One such application is utilizing fluids (some examples include wind, rain, water, storm drains, gutter, drain, outflow, etc.) It is beneficial to have a device that may use these as input or be moved or powered by these.

For one subexample a form of channeler, or director, may be utilized to direct some of the inputs above to a device that can utilize it to produce, create, supplement or store energy. Another subexample may have a form of plate (straight, curved or various other shapes) channeling towards a device. It may be specially formed (may be mobile, movable, flexible) at one or more locations to direct this towards the device. (It may be movable, and/or have members whose direction can be changed).

Another application is using mass or weight to drive a device (One subexample is the weight of people or vehicles passing over) For example, these could be used to power a piston,

Generator, mill, turbine, or various other forms of devices.

These may take various forms. (For 1 example, ramps, over which vehicles pass may be used) This may be a (possibly flexible) ramp or attached to or leading to a plate which may be movable and may be used to actuate or move a device.

The above are only representative descriptions of some possible applications of these embodiments and concepts. Various other implementations applications, and variations of this invention are also possible. These are also intended to be included.

What is claimed is:

1. A device, devices, or components that can utilize 1 or more or various forms of input to generate or store energy.

2. A device as in claim 1, that can utilize the mass, weight, motion, etc. of people or vehicles, etc. to perform and/or assist functions including producing energy, creating force, storing power etc.

3. A device as in claim 2 that that can generate or store energy by means including, movement, depression, rotation, etc.

4. A device as in claim 1 that can produce energy by means of depression, passing over, movement through, depressing, etc. a member

5. A device as in claim 1 that can produce energy by moving a wheel, turnstile, piston, turbine, etc.

6. A device as in claim 2 that can generate energy by movement of devices including examples such as or similar to turnstile like device(s), speed bump, toll device, etc

7. A device (and/or member placed near) that can utilize fluid(s) (such as wind, water, rain, gutter, fresh or waste water, sewage, outflow, etc) to produce or store energy

8. A device or member as in claim 7, (or device or barrier placed near)
that channels fluid(s) (such as wind, water, rain, gutter, sewer, outflow, etc) to produce or store energy

9. A device as in claim 7, with hole(s) or space(s), channel (s), indent(s), groove(s), etc. to move, channel, or direct, fluid to produce energy or to a device that can.

10. A device as in claim 1, to move, channel, direct, etc. one form of motion, energy, etc. to produce energy

11. A device as in claim 1, that may use fiber or waveguide(s), etc to move, channel, direct, etc. one form of motion, energy, etc. to produce energy (possibly in various or a different form including light, heat, etc.

12. A device as in claim 7 with a plate (or (semi) rigid material(s) and/or groove(s) that channels input to produce energy and/or directs it towards a device that can generate energy.

14. The device of claim 7 where there are somewhat cylindrical or tunnel, or windmill or wheel shaped, or surface areas to channel or utilize inputs, energy, etc.

13. A device as in claim 7, or similar device which may be placed in front of, near, below, or above a source of fluid, faucet, sink, drain, etc. that can produce one or more forms or energy

14. A plate as in claim 1 that is depressed producing energy.

15. A rotating device as in claim 1 that can produce energy

16. A device as in claim 1 such as a wheel, turnstile, etc. whose rotation can produce energy.
